(19) United States
(12) Patent Application Publication
(10) Pub. No.: US 2006/0267966 A1
(43) Pub. Date: Nov. 30, 2006

(54) Hover widgets: using the tracking state to extend capabilities of pen-operated devices

(75) Inventors: Tovi Samuel Grossman, Toronto (CA); Kenneth P. Hinckley, Redmond, WA (US); Patrick M. Baudisch, Seattle, WA (US); Maneesh Agrawala, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/245,850

(22) Filed: Oct. 7, 2005

Related U.S. Application Data
(60) Provisional application No. 60/683,996, filed on May 24, 2005.

(51) Int. Cl. G09G 5/00

(52) U.S. Cl. 345/179

(57) ABSTRACT

A technique for increasing the capabilities of pen-based or touch-screen interfaces. The capabilities are implemented by using movements at a position above or in a parallel proximity to the display surface, referred to as a tracking or hover state. A gesture or series of gestures in the hover or tracking state can be utilized to activate localized interface widgets, such as marking menus, virtual scroll rings, etc. The gesture(s) can be preceded or followed by an optional authorization that confirms a command, action, or state. Utilization of a tracking state allows the disclosed systems, methodologies and/or devices to create a new command layer distinct from the input layer of a pen or touch display interface. Thus, user commands can be localized around a mouser or pointer maintaining user concentration while eliminating the occurrence of undesired or unintended inking on the display surface.

### CROSS-REFERENCE TO RELATED APPLICATIONS

This is an application claiming benefit under 35 U.S.C. §119(e) of U.S. Provisional Patent Application Ser. No. 60/683,996, filed May 24, 2005, and entitled “EXTENDED CAPABILITIES OF PEN-OPERATED DEVICES.” The entirety of this application is incorporated herein by reference.

### BACKGROUND

Pen based interfaces are effective tools for a variety of tasks, such as freeform note taking and informal sketch design. However, these devices typically lack the keyboard keys, buttons, and/or scroll wheels that offer shortcuts for common tasks on the desktop. This forces the user to zigzag the pen back and forth between the work area or display and the system menus, which are generally located at the top, bottom, and/or sides of the display. This slows the user down and diverts their visual attention from the actual task at hand.

Localized user interface elements (e.g., pop-up menus, pen gestures, tracking menus) attempt to solve this problem by bringing the interface to the locus of the user's attention, as indicated by the current location of the pen. A significant challenge for localized interfaces is that the user needs to somehow invoke them, such that a pen stroke on the screen activates the interface rather than leaving behind ink or other marks on the display screen and underlying document. Even with the use of a well-crafted gesture recognition engine, there is a risk for unrecognized gestures to be misinterpreted as ink, or for strokes intended as ink input to be falsely recognized as gestures, causing unexpected and potentially undesirable results.

One approach to address this problem is to require the user to press a physical button to explicitly distinguish between command modes (e.g., gestures, menus, tools) and a raw ink input mode. A button can provide an efficient and effective solution, but in some situations it is not practical. For example, some users prefer a pen-only experience, many mobile deices or electronic whiteboards lack a suitable button, and, even if a button is available, it may be awkward to use while holding the device.

Many pen devices, including Wacom Tablets, Tablet PC's and some electronic whiteboard sensors, support a tracking state. The tracking state senses the pen location while the pen is proximal to the interaction surface. However, the uses for the tracking state are limited to cursor feedback.

Gesture-based systems for pen input are carried out on the surface of the display. A documented difficulty associated with this technique is that the gestures can be confused with the ink, causing unexpected results that should be undone. Even the most obscure gesture could be falsely recognized—if the user was illustrating the system's gestures, for example, then those illustrations would be recognized as the gestures that they illustrate. To alleviate this problem, some systems require users to switch between ink and gesture modes. For example, a button used by the non-dominant hand can be an effective method for this mode switch. Other localized interaction techniques, such as pop-up menus, are generally activated with physical buttons. Two implementations of localized scrolling techniques recently developed support scrolling as the only input mode, so their invocation is not an issue.

A hover, or tracking, state of the pen is one of three states sensed by pen-based systems. Usually, this state is used to track the current position of the cursor. For example, tool tips can be provided when a user hovers above an icon. These pop-up boxes display information about the icon, but cannot be clicked or selected. Another example is a system that supports a gesture made in the tracking state. If the user scribbles above the display surface, a character entry tool pops up. Some users may find this feature irritating. It can be activated accidentally, and there is no visual guidance showing the user what to do for the gesture to be recognized.

In another example, users can share documents between multiple tablet PCs by performing a drag gesture from one device to another called a “stitching” gesture. In one of the designs, this gesture could be done in the tracking zone of the displays.

The tracking menu is an interactive interface widget that relies on hover state actions. The menu is a cluster of graphical widgets surrounded by a border that the cursor moves within. If the cursor reaches the menu's border while moving in the tracking state, the menu moves with the cursor. As a result, the contents of the menu are always in close proximity to the cursor. This technique works well when a user needs to frequently change between command modes, such as panning and zooming. However, when a tracking menu is activated, the user can only execute commands appearing in that menu. The menu should be deactivated when the user returns to data entry. An alternate design supports a pen zone, where the user can click to begin an ink stroke. However, this limits a stroke's starting point to the current area covered by the pen zone of the menu. Every time a stroke needs to start elsewhere, the user would first need to reposition the tracking menu, such that the ink zone aligned with their starting point. This two-step approach would not be desirable for a user relying on a fluid interface, such as a sketch artist. Thus, there is a need to provide a technique for increasing the capabilities of pen-based interfaces that mitigates the aforementioned deficiencies.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

Embodiments describe a system, method and/or device that support localized user interface interactions in pen interfaces. Provided is a novel technique that extends the capabilities of pen-operated devices by using the tracking state to access localized user interface elements. According to an embodiment a Hover Widget is invisible to the user during typical pen use, but appears when the user begins to move the pen along a particular path in the tracking state, and then activates when the user reaches the end of the path and brings the pen in contact with the screen.

According to an embodiment, the widget uses the tracking state to create a new command layer, which is clearly distinguishable from the input layer of a user interface. A user does not need to worry about the system confusing ink and gestures. The widgets are always local to the cursor, which can save the user time and movement. According to another embodiment, the widgets allow users to maintain their focus of attention on their current work area. If a user is reading the bottom of a page that they are annotating, a gesture in the hover state can be used to activate a virtual scroll ring, allowing the user to scroll as they continue to read. The user would not have to shift their attention to a small icon on the border of the display to initiate scrolling.

According to another embodiment is a mechanism to quickly bring up other localized user interface elements, without the use of a physical button. Virtual scroll ring activation offers one example. Another example is using a widget to activate a marking menu. In another embodiment, the widgets can be integrated into pen-based user interfaces, allowing fast transitions between ink and commands. If a user notices a mistake in a document while scrolling, they can lift the pen and draw a circle around the mistake. The user then repeats the gesture to activate the scroll tool and continues scrolling.

To the accomplishment of the foregoing and related ends, one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that utilizes a tracking state to extend the capabilities of a pen-operated or touch screen device.

FIG. 2 illustrates a system that facilitates locating an object in a tracking state.

FIG. 3 illustrates exemplary gestures that can be utilized to invoke commands, menus or other actions in the tracking state.

FIG. 4 illustrates exemplary two-level strokes that can be utilized with the embodiments disclosed herein.

FIG. 5 illustrates a system for transitioning between an ink mode and a command mode utilizing gestures in a tracking state.

FIG. 6 illustrates a system that utilizes Hover Widgets in according with the various embodiments disclosed herein.

FIG. 7 a system for providing user-guidance to invoke a Hover Widget is illustrated.

FIG. 8 illustrates a Hover Widget during various stages including initiation of a stoke to activation of a widget.

FIG. 9 illustrates an embodiment for gesture recognition and visualization.

FIG. 10 illustrates visualization techniques that can be utilized with the disclosed embodiments.

FIG. 11 illustrates another embodiment of a visualization technique utilized with the subject disclosure.

FIG. 12 illustrates a system for allowing a confirmation or activation of a command invoked in a tracking state.

FIG. 13 illustrates an exemplary user interface control panel that can be utilized with the disclosed embodiments.

FIG. 14 illustrates a methodology for utilizing a tracking mode to switch from an ink mode to a command mode.

FIG. 15 illustrates a methodology for an initiation of a command after a user authentication and gesture.

FIG. 16 illustrated is a methodology for providing assistance to a user for completion of a gesture.

FIG. 17 illustrates a block diagram of a computer operable to execute the disclosed embodiments.

FIG. 18 illustrates a schematic block diagram of an exemplary computing environment operable to execute the disclosed embodiments.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component,” “module,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, device, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject embodiments.

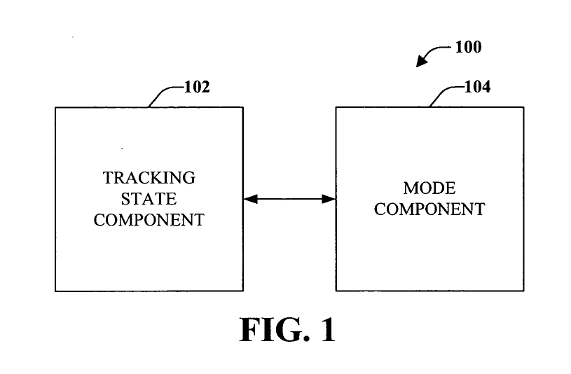

Referring initially to FIG. 1, illustrated is a system 100 that utilizes a tracking state to extend the capabilities of a pen-operated or touch screen device. The system 100 includes a tracking component 102 that interfaces with a mode component 104. The system 100 can be utilized with a plurality of pen-operated devices that can range in size and includes handheld devices, tablet PCs, tabletop displays, wall-sized displays, etc.

The tracking state component 102 is configured to recognize and distinguish an object (e.g., pen, finger) in a tracking state. The tracking state is an area that is just above or next to the front surface of a display. The tracking state is a layer or location that is in parallel with the display. The tracking state is the position when an object is not in physical contact with the display and not so far removed from the display that it has no significance with the operation of the device and/or cannot be recognized by the tracking state component 102. It is to be understood that while various embodiments are described with pen-operated devices, the disclosed embodiments work well with devices capable of perceiving or distinguishing an object in a tracking or hover state. The object does not have to be a pen, rather, the object can be a finger, such as for wall-mounted or wall-size display. The object does not have to be something that is carried about from place to place nor does it require technology to operate. Examples of items that can be utilized as an object recognized by the tracking state component 102 include hand(s), finger(s), pen(s), pencil(s), pointer(s), marker(s), dot on finger, and/or other items or objects that can be recognized by the system. Virtually anything the system can track can be utilized to invoke a menu, command or other action. In another embodiment, the system can include one or more camera or optical means to detect an object in the tracking state.

More than one person can interact with the display at substantially the same time. Each person can utilize a different object and a different portion of the display. The number of people that interact with the system 100 can be as many people as can gesture that are in proximity to the system 100 and which the system 100 can recognize. It is to be understood that the system 100 can be utilized in pen-operated devices that do not support multiple touch technology, however, if it is desired to allow more than one user to interact with the system 100 at substantially the same time, multiple touch technology should be utilized.

The tracking state component 102 is configured to track both the distance of the object from the screen and the path of the object (e.g., up to a three-dimensional placement of the object). The tracking state component 102 can distinguish movement of the object that is intended to perform an inking function (e.g., placing the cross in a “t” or dotting an “i”). These types of actions or gestures are those commonly utilized to move the pen to different location on the screen or display.

The tracking state component interacts with the mode component 104 that interprets a movement of the object and provides a functionality. The interpretation can include accessing a database, data list, data store, memory, storage unit, or other means of maintaining gestures in the tracking state and commands and/or actions associated with those gestures. The movement interpretation can include an interpretation of gestures that commonly occur but which are not meant to invoke a command and/or another action. When such gestures in the tracking state are recognized, the system 100 can disregard the gesture.

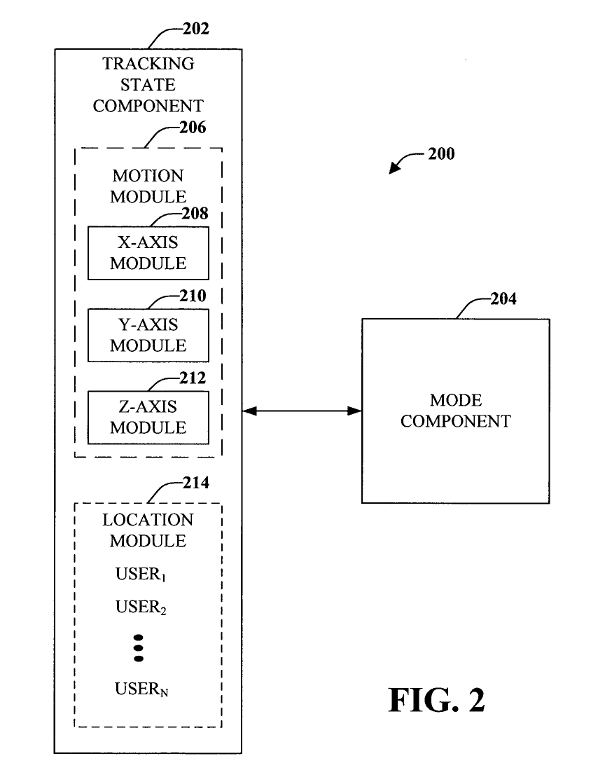

FIG. 2 illustrates a system 200 that facilitates locating an object in a tracking state. The system includes a tracking state component 202 that interfaces with a mode component 204. The tracking state component 202 includes a motion module 206 that is configured to track an object in the tracking state through a plurality of directions including the x-axis or horizontal direction, the y-axis or vertical direction, and the z-axis or distance away from the screen. A motion can include an x-axis piece of motion, a y-axis piece of motion, and a z-axis piece or motion, or any combination of these. The motion module can include an x-axis module 208, a y-axis module 210, and a z-axis module 212. It is to be understood that while these modules 208, 210 and 212 are illustrated and described with reference to the tracking state component 202 and/or the motion module 206, they can be modules separate from the tracking state component 202 and/or the motion module 206. In other embodiments, there can be more or less modules than those shown and described.

The x-axis module 208 is configured to determine a horizontal motion of the object in the tracking state and the y-axis module 210 is configured to track a vertical motion of an object in the tracking state. The z-axis module 212 is configured to differentiate between an object in contact with the display or work space and an object that is in a parallel proximity to the display space (e.g., in the tracking state). The parallel proximity can include the distance from just off the screen to a predetermined distance from the screen. For example, small displays, such as a table PC, the maximum distance between the object and the screen can be one inch. If the object is in a state between actual contact with the screen and about an inch away from the screen, this distance can be the tracking state. For larger displays, such as a wall-sized display, the tracking state lay can be anywhere from touching the display to a foot or more away from the display. It is to be understood that the described distances are for illustration purposes only and other distances can be utilized and fall within the scope of the systems, methods and/or devices disclosed herein.

Furthermore, a windowing system can designate regions of the screen x-axis, y-axis, and/or portions of the z-axis (which can also be described as volumes of x, y, z, space). These regions may change some or all of the functions triggered by hover gestures associated with each region of the screen, including “no function” (e.g., hover gestures disabled in a region). The windowing system can further be applied to hover widgets. For example, a hover gesture over one window or region might perform functions different than if it is over another window or region. For example, a hover widget over one region might be ignored but when over another region it performs a function.

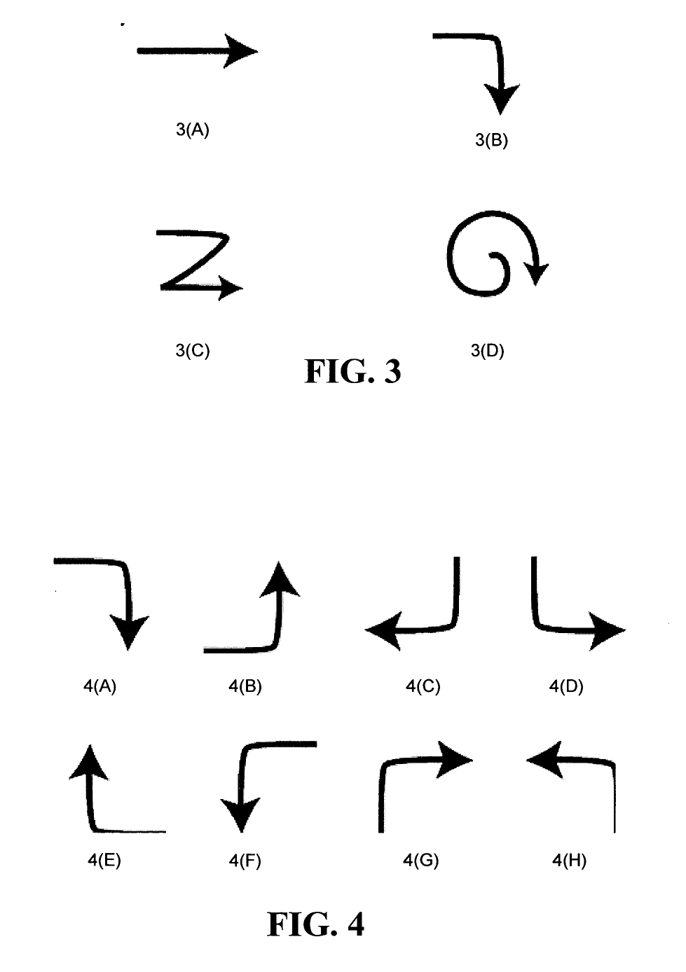

A plurality of gestures can be utilized in accordance with system 200. Gestures can include a single-level stroke, a two-level stroke, a three-level stroke, and a spiral stroke. Another gesture can include a spike gesture. Other curved forms such as U-shaped, S-shaped, circular, ovoid, or curlicue gestures also form possible hover gestures. Furthermore, a default hover gesture recognized by a system can depend on the handedness or language spoken by the user. For example, Arabic users write right-to-left and use different movement patterns for writing, and thus may desire to use different hover widgets that best accommodate the natural pen movements for Arabic writers. It should be understood that other stoke levels can be utilized. For example, a ten-level sequence of strokes can be utilized, however it would be harder to perform but less likely to occur by accident. Various exemplary gestures will be discussed further below with reference to FIG. 3. The complexity or simplicity of a particular gesture should be in proportion to the occurrence of a similar gesture occurring accidentally in the tracking state. For example, there are some gestures that a user may make while moving the pen from one location to another, such as placing the line in a “t.” In the tracking state this gesture would appear as a diagonal line from the bottom (or top) of the vertical line in the “t”. Thus, a diagonal line may not be the best gesture in the tracking state to invoke a command. Such a diagonal line hover gesture might be useful in certain applications where the user was not expected to use the pen for natural handwriting. Therefore, straight-line hover gestures are feasible according to some embodiments.

With continuing reference to FIG. 2, the tracking state component 202 can further include an optional location module 214 that is configured to track a plurality of users or objects that interact with the system 200 at substantially the same time. There can be any number of users that interact with the system 200, shown as User₁, User₂, . . . User_{N}, where N is a number equal to or greater than one. It should be understood that the location module 214 should be used with a system 200 that supports multiple touch technology. Each user can interact with the system independently. In some embodiments, the location module 214 can be considered as a user identification module, such as on certain pen technologies that allow a unique identification code to be sensed from the pen. This code might be embedded in the pen itself (e.g., as an RFID tag), or even sensed by the pen through fingerprint recognition technology, for example.

The gesture(s) detected by the tracking state component 202 are communicated to the mode component 204 to facilitate invoking the command requested. There can also be an optional confirmation or authentication action required by the user to invoke the command. This confirmation or authentication action can be performed before or after the gesture, depending on user and/or system requirements.

Exemplary gestures that can be utilized to invoke commands, menus, or other actions (hereinafter referred to as a “Hover Widget”) in the tracking state are illustrated in FIG. 3. The gestures that activate the Hover Widget(s) should not occur in natural hover or tracking state movements, otherwise, Hover Widgets would be activated unintentionally. This presents a trade-off between complexity and ambiguity. If too complex, the gesture will not be rapid. However, reducing the complexity may increase ambiguity, causing unintentional activations.

The simplest gestures consist of a single direction stroke(s) and there are also compound stroke gestures with one, two, or more corners. A single level stroke is a simple line drawn (or an object movement) in any direction and is illustrated at 3(A) as moving in the rightward direction. Although the single-level stroke is simple, it would cause too many false activations, since the object only needs to move in the corresponding direction. The single-action motion illustrated would be detected by the x-axis module 208 for the horizontal direction and the z-axis module 212 to discriminate between a stroke or object movement in contact with the screen or in the tracking or hover state.

At 3(B) illustrated is a two-level stroke, which is more appropriate with the embodiments disclosed herein and include, for example, “L” shaped strokes that include 90° angles. Two-level strokes have minimal complexity and the sharp corners (e.g., 90° angle) generally do not occur in tracking state actions accidentally. The two-level stroke illustrated would be detected by the x-axis module 208, the y-axis module 210, and the z-axis module 212. The “L” stoke is shown moving in a particular direction, however, a plurality of “L” strokes can be utilized as will be discussed below.

While two-level strokes may be a good shape in terms of the complexity-ambiguity tradeoff, there no reason more complex strokes cannot be utilized with the disclosed embodiments. A three-level stroke is illustrated at 3(C). These strokes further increase movement time and can be utilized to further mitigate accidental activations. Spirals can also be utilized, as illustrated at 3(D). Although these strokes are more complex, they can be utilized to increase the vocabulary of an interface utilizing the disclosed Hover Widgets. Both strokes illustrated at 3(C) and 3(D) are detected by the x-axis module 208, the y-axis module 210, and the z-axis module 212.

FIG. 4 illustrates exemplary two-level strokes that can be utilized with the embodiments disclosed herein. The “L” shaped stroke is simple and easy to learn and utilize to invoke various commands. The eight possible “L” shaped orientations are shown at 4(A) through 4(H). It should be appreciated that while an “L” shape is shown, other gestures work equally well with the systems and/or methods disclosed herein. Each gesture starts at a different position along the horizontal direction (x-axis) and the vertical direction (y-axis). Each of the eight “L” shaped orientations can be drawn in the tracking state to invoke eight different commands. It should be appreciated that other two-stroke gestures, one-stroke gestures, three-stroke gestures, and/or spiral gestures can have different orientations that are similar to those of the “L” shaped orientations shown at 4(A) through 4(H).

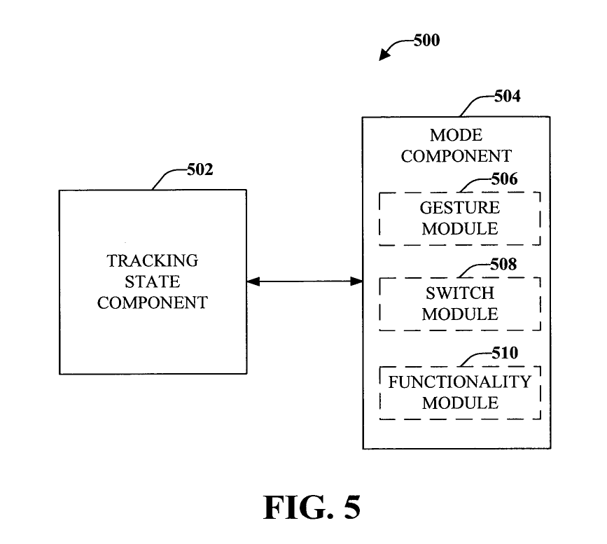

Referring now to FIG. 5, illustrated is a system 500 for transitioning between an ink mode and a command mode utilizing gestures in a tracking state. System includes a tracking state component 502 that interacts with a mode component 504. The tracking state component 502 functions in a manner similar to that shown and described above. At substantially the same time as a gesture in the tracking state is identified by the tracking state component 502 the information relating to the gesture is sent to the mode component 504 through an interface between the tracking state component 502 and the mode component 504. The mode component 504 is configured to determine that command being activated and switch from an ink state to a gesture command state.

The mode component 504 can include various modules to perform a command determination and switch. These modules can include a gesture module 506, a switch module 508, and a functionality module 510. While the modules 506, 508, and 510, are illustrated and described with reference to the mode component 504, it is to be understood that the modules 506, 508, and 510 can be separate and individual modules. It should also be understood that there can be more or less modules utilized with the subject disclosure and are shown and described for purposes of understanding the disclosed embodiments.

The gesture module 506 maintains a listing of gestures that can be utilized to initiate a command or a Hover Widget. The listing can be maintained in a plurality of locations including a database, a data store, a disk, memory, or other storage means that is configured to maintain a listing of gestures and that is further configured to readily access and interpret such gestures. The gestures maintained by the gesture module 506 can include gestures that invoke a command or Hover Widget as well as gestures that occur frequently in the tracking state, but which are not intended to invoke a command or Hover Widget.

The gesture module 506 can be configured to provide a user a means to create user-defined gestures that invoke a command or Hover Widget. The user can perform a gesture in the tracking state and interface with the gesture module 506 for a determination whether the gesture can be utilized to invoke a command. The gesture module 506 can access the database, for example, and calculate how likely the user-defined gesture can happen by accident (e.g., a common gesture). Thus, the gesture module 506 can discriminate among gestures and designate a user-defined gesture as usable or not usable. For example, if the user draws a straight line in the tracking state and intends for the straight line to invoke a command, the gesture module 506 will return with an indication that the particular gesture is common and should not be utilized to invoke a command. Thus, based on logged analysis the gesture module can enhance the user experience and provide user-defined gestures that are meaningful to the particular user. This logged analysis can also be partitioned on a per-application basis, if desired, for definition of gestures specific to a single application.

The switch module 508 is configured to switch the system 500 between an ink mode and a command mode. When a command mode is over the switch module 508 facilitates the system 500 returning to an ink mode. The switch module 508 can discriminate between an ink mode and a command mode based upon an authentication or other indication that the user intends for such a switch to occur.

The functionality module 510 is configured to provide the command invoked by a particular gesture in a tracking state. The command invoked can include a plurality of functions including a selection tool, right click, scrolling, panning, zooming, pens, brushes, highlighters, erasers, object creation modes (e.g., add squares, circles, or polylines), insert/remove space, start/stop audio recording, or object movement modes. Non-modal commands can also be included in hover widgets. The functionality module 510 can also provide the user with a means to define the gesture to activate when a particular gesture is made in the tracking state. For example, the user can set up a function so that when the user activates a right click, when the pen or object moves on the screen it will choose different right click commands. Another example is if the user chooses the scroll tool and moves the pen or object on the screen, it activates a scrolling menu allowing the user to navigate through the document. Thus, the functionality module 510 can, though a user-interaction, modify what the system 500 interprets the pen or object the screen as meaning.

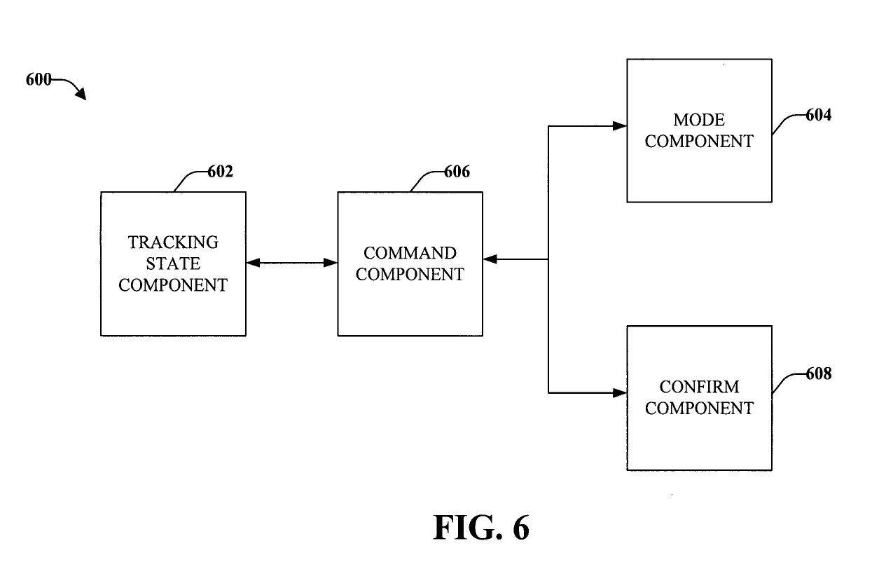

FIG. 6 illustrates a system 600 that utilizes Hover Widgets in according with the various embodiments disclosed herein. Hover Widgets, as discussed above, are a novel technique that extends the capabilities of pen-operated devices by using the tracking state to access localized user interface elements. A Hover Widget can be invisible to the user during typical pen use (e.g., inking), but appears when the user begins moving the pen along a particular path in the tracking state. The Hover Widget can activate when the user reaches the end of the path. Optionally, the user can activate the Hover Widget after the path is completed by bringing the pen in contact with the screen or through another confirmation gesture (e.g., double tapping, pausing with the pen above the screen for a time interval, pressing the pen button, . . . ).

System 600 includes a tracking state component 602 that interfaces with a mode component 604 through a guidance component 606. The system 600 can also include an optional confirm component 608. The tracking state component 602 detects an object in the tracking state and can further detect the presence of one or more objects in the tracking state at substantially the same time. The tracking state component 602 can interact with a command component 606 to assist a user in completing a command invoking gesture. For example, the command component 606 can assist the user by providing a path or tunnel that the user can emulate to complete an appropriate gesture. The mode component 604 receives the completed gesture and invokes the desired command. Alternatively or in addition, the command component 606 can interface with a confirm component 608 that, through a user interaction, receives a confirmation or authentication that the selected gesture and corresponding command is the command desired by the user to be activated. The user can confirm the request through a plurality of confirmation movements or interfaces with the system 600. The confirm component 608 can interact with the mode component 604 to provide authentication of the command and such authentication can be initiated before or after the gesture is performed in the tracking state.

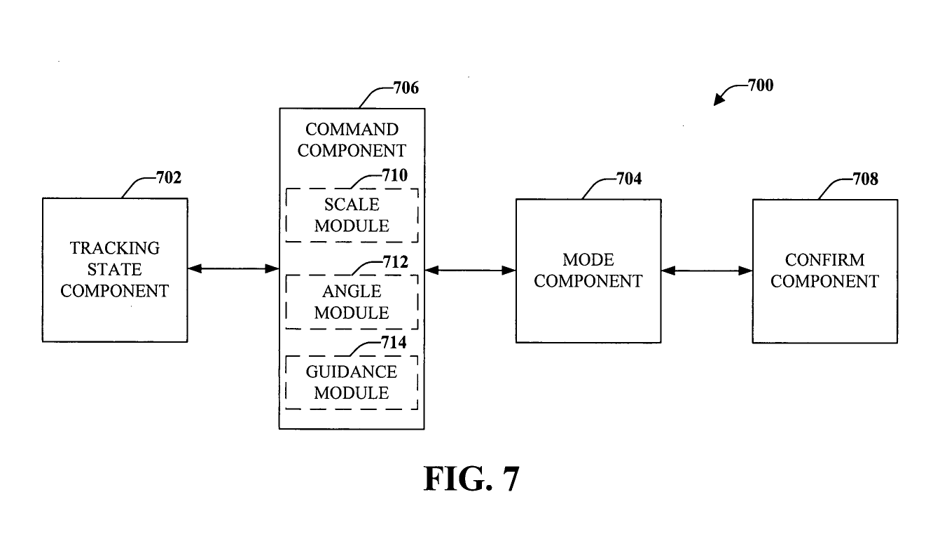

With reference now to FIG. 7, a system 700 for providing user guidance to invoke a Hover Widget is illustrated. At substantially the same time as a tracking state component 702 interprets a movement or path of an object in a tracking state, the command component 706 can offer the user assistance to complete an anticipated command. The command component 706 can include various modules that facilitate user guidance including a scale module 710, an angle module 712, and a guidance module 714. It is to be understood that while the modules 710, 712, and 714 are shown and described with reference to command component 706, they can be individual modules that are invoked separately. In addition, there can be more or less modules that that shown and described and all such modifications are intended to fall within the scope of the subject disclosure and appended claims.

The optional scale module 710 can regulate the size of a gesture in the tracking state. An entire gesture can be limited to a certain size or a subpart of the gesture can be limited to a particular size. If the gesture is made in the tracking state that does not conform to the predefined scale, the gesture is disregarded and does not invoke a command. By way of example and not limitation, if the shape of a gesture is a “W” various segments of the shape can be size-dependent. The entire “W” itself might need to be between one inch and two inches and if the shape is drawn either under one inch or over two inches, the gesture will be disregarded. Alternatively or in addition, each leg of the “W” might be scale dependent. In another embodiment, the gesture shape(s) can be scale independent. With reference to the above example, for a scale independent gesture, each leg of the “W” can be a different size. The first leg or stroke can be short, the next two legs or strokes can be large and the last leg or stoke can be short. A scale independent gesture provides the user with flexibility and the ability to quickly make gestures. In another embodiment, some gestures can be scale dependent while other gestures are scale independent. The determination of scale dependency of a gesture can be identified by a user, a system designer, or another individual and can depend on the skill-level of a user or as way to mitigate unauthorized users who are not familiar with the scale dependency to invoke the command(s).

The angle module 712 is an option module that can limit the tracking state gesture(s) to lines connected with a predefined angle and those gestures that meet the angle criteria invoke a command while gestures that do not meet the angle criteria are disregarded. The angle module 712 mitigates the occurrence of gestures made accidentally in the tracking state invoking and undesired or unintended command. Generally, gestures in the tracking state that are made randomly do not contain sharp angles. Thus, the angle module 712 can be configured to accept gestures, such as an “L” shaped gesture, when the vertical and horizontal portions are connected with an angle between 80 degrees and 100 degrees. However, the embodiments herein are not so limited.

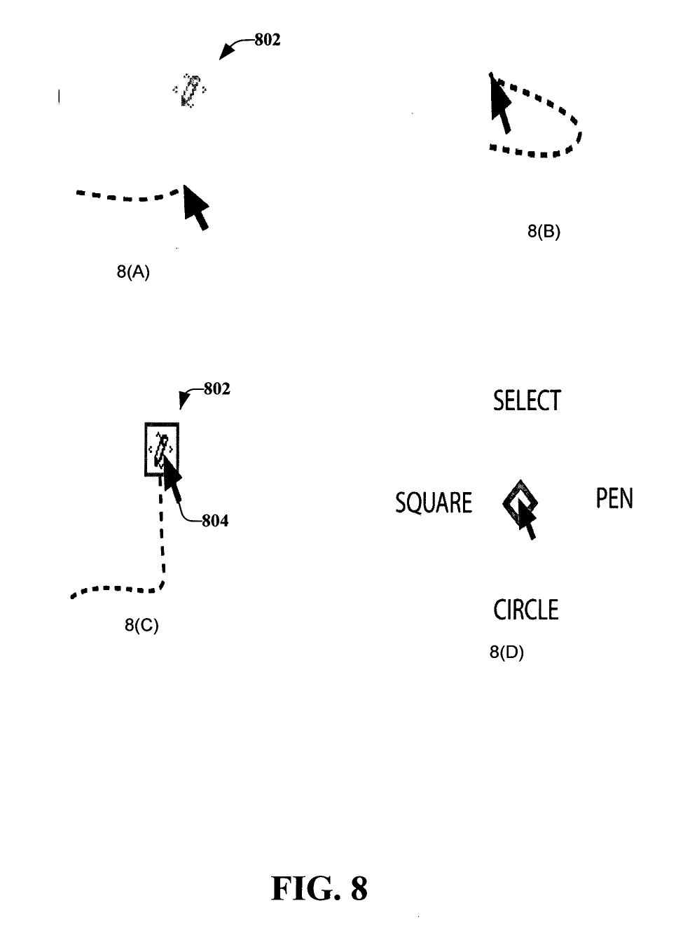

The guidance module 714 can provide a user with a tunnel or path to follow if an object path has been interpreted by the system 700 as the beginning of a gesture that can invoke a Hover Widget. In another embodiment, the guidance module 714 can be invisible but appear when a gesture is detected in the hover state. Further detail regarding the guidance module is described and illustrated below with reference to FIGS. 8, 9, 10 and 11. It should be understood that the various embodiments disclosed with references to the guidance module 714 are for example purposes and are not intended to limit the various embodiments disclosed herein to these specific examples.

FIG. 8 illustrates a Hover Widget during various stages ranging from initiation of a stroke to activation of the widget. A user can set-up a Hover Widget so that it is invisible to the user during typical pen use, but appears when the user begins to move along a particular path in the tracking state. For example, a user might form a backwards “L” shape to activation a menu (e.g., marking menu). As illustrated at 8(A), when the user begins a Hover Widget gesture, the target 802 fades in and is visible on the display screen. The dashed line illustrates the object's path in the tracking state. If the user exits the gesture at any time before completing the gesture, the target fades out, as indicated at 8(B). Exiting the gesture requires the user to begin the gesture again in the tracking state.

If rather than exiting the gesture, the user completes the gesture, at 8(C), the cursor 804 is over or pointing to the associated Hover Widget 802. The user can then click on the widget to active it. To click on the widget the user can bring the object into contact with the display and tap on the display at the location where the widget 802 is displayed. Once the user selects the widget 802, the selected command is displayed. As illustrated at 8(D) a marking menu can become visible to the user. The user can then quickly select the desired action without having to move the pen or object back and form between a menu and the particular task at hand, thus, remaining focused.

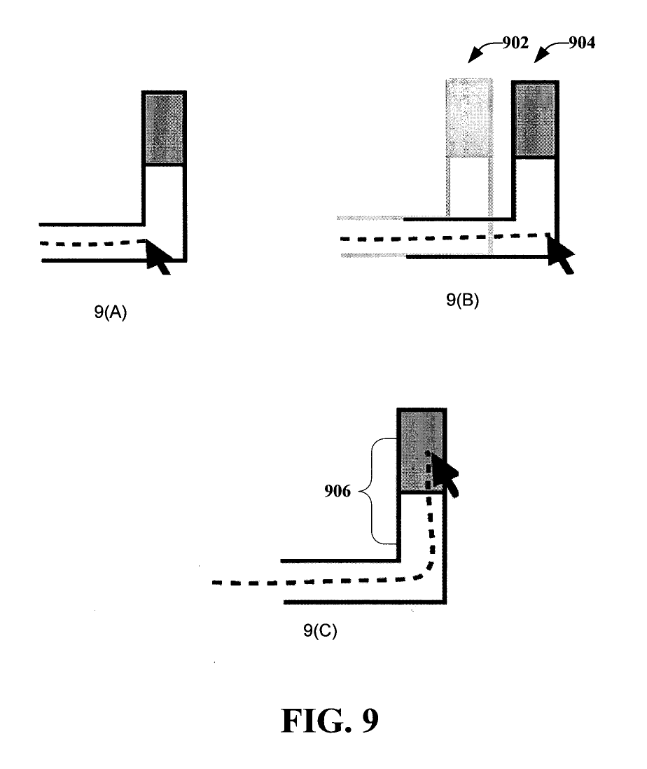

With reference now to FIG. 9, illustrated is an embodiment for gesture recognition and visualization. To provide guidance to a user to facilitate learning and usage of Hover Widgets the user should understand how they are visualized and how the system recognizes them. The visualization should convey to the user the exact requirement for either invoking the command or preventing the command from occurring.

According to an embodiment is to use gestures that are constrained and guided by boundary walls surrounding the target stroke, creating a tunnel that the user should traverse to invoke the command. An embodiment of a tunnel is illustrated in FIG. 9. The visual appearance of the tunnel defines the movements the user should make with the object to activate the associated Hover Widget. A benefit of using such a simplified gesture recognition strategy is that user will quickly understand what action to take to activate a Hover Widget. Using the tunnel boundaries also makes the gesture recognition algorithm relatively simple. Other more complicated embodiments can be utilized to improve performance, but such complication could render the recognition system challenging to visualize complex gesture constraints.

As illustrated at 9(A), a cursor moves through the Hover Widget tunnel. This cursor movement is achieved by an object moving in the tracking state. If the cursor leaves the boundaries of the tunnel, the origin on the tunnel can be repositioned to the earliest point of the current hover stroke, which could begin a successful gesture, as illustrated at 9(B). For example, the tunnel can be repositioned from location 902 to location 904 if the cursor leaves the tunnel boundaries. As long as the user's stoke ends with the required movements, the Hover Widget will be activated. This makes the “L” shaped gesture (or other shaped gestures) scale independent since the first segment of the stoke does not have a maximum length. The Hover Widget can be activated, shown at 9(C) once the object reaches the activation zone, shown at 906. As a result of this algorithm, sections of the tunnel boundaries act similar to the borders in tracking menus.

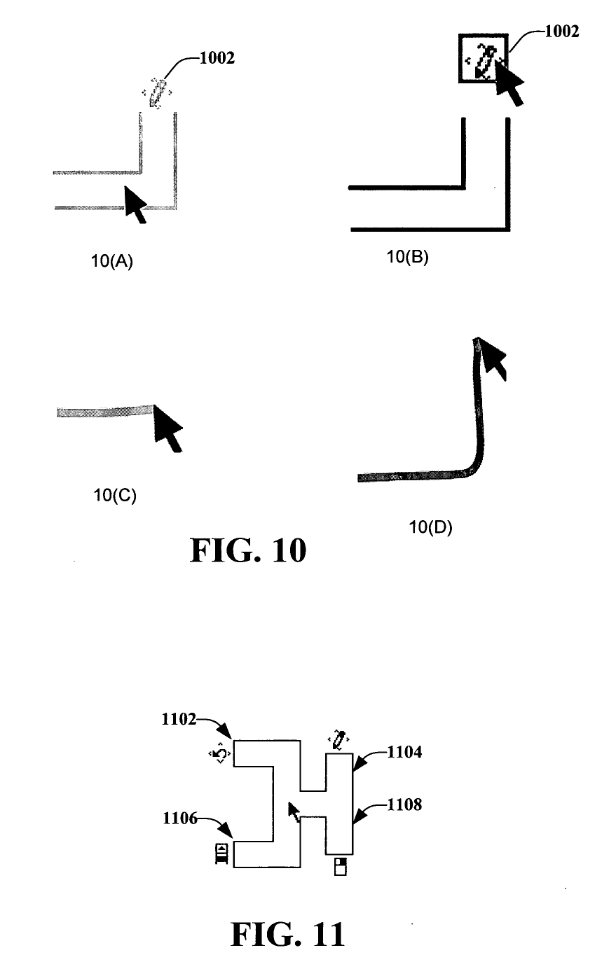

With reference now to FIG. 10, illustrated are visualization techniques that can be utilized with the disclosed embodiments. Recognition should be correlated to how the Hover Widgets are visualized. While drawing the tunnels can be beneficial to a user learning to user the Hover Widgets, seeing the tunnels at all times might become visually distracting, especially when the Hover Widgets are not being used. An experienced user may not need to see the tunnel at all. Thus, various strategies for visualizing the Hover Widgets can be utilized so that the user sees what they need to see, when then need to see it.

Both the tunnel and the activation zone can either be displayed or hidden. When displayed, a fade-in point can be set, which defines how much progress should be made before the widget becomes visible. For example, a user may only want to see the activation zone or tunnel after they have progressed through about 40% of the tunnel, shown at 10(A). Once the cursor reaches the fade-in point, the widget slowly fades in. The activation zone is displayed as a square icon, 1002, which illustrates its associated functionality. Because the activation zone is generally rectangular, the icon 1002 can drag along with the cursor until it exits the region, as shown at 10(B).

According to another embodiment, a visualization technique can be a cursor trail. The path that the cursor has taken is shown, beginning at the tunnel origin, and ending at the current cursor location, as illustrated at 10(C). If the cursor completes the gesture, the trail can turn a different color (e.g., green), indicating that the Hover Widget can be activated, as illustrated at 10(D).

FIG. 11 illustrates another embodiment of a visualization technique utilized with the subject disclosure. This embodiment utilizes a dwelling fade-in that can be utilized where the Hover Widget becomes visible if the object dwells in any fixed location of the tracking zone. This is useful when multiple tunnels are present, so users can see which tunnel to follow to access a certain Hover Widget. The following example will be discussed in relation to a painting program, where the full functionality of the application is access through Hover Widgets. It is to be understood that Hover Widgets are not limited to drawing applications.

Hover Widgets can replace desktop user interface elements using localized interactions. In an application, the Hover Widgets can complement standard menus and/or tool bars. Placing all functionality within the Hover Widgets, extends a capability for the user.

As illustrated in FIG. 11, four “L” shaped Hover Widgets can be used in an embodiment. The user would only see this entire “road map” if a dwelling fade-in occurred. A first “L” shape, 1102, can be associated with a Tools Hover Widget. A second “L” shape, 1104, can be associated with an Edit Hover Widget. A third “L” shape, 1106, can be associated with a Scroll Hover Widget, and a fourth “L” shape, 1108, can be associated with a Right Click Hover Widget. The functionality of each widget 1102,1104, 1106, and 1108 will now be described.

The Tools Hover Widget 1102 can be thought of as replacing an icon toolbar, found in most drawing applications. Activating the Hover Widget can bring up a single-level marking menu. From this menu, the following command selections can be available: selection tool, pen tool, square tool, circle took, and pen properties. The pen properties option can bring up a localized menu, allowing users to select the color and width of their pen.

The Edit Hover Widget 1104 can replace the standard “Edit” menu, by brining up a marking menu. Its options can include the commands typically found in an application's “Edit” menu. For example, the Edit Hover Widget 1104 can provide commands such as undo, redo, clear, cut, copy, and paste.

The Scroll Hover Widget 1106 allows users to scroll without the need to travel to the borders of the display. It can be though of as replacing the scroll wheel of a mouse. Activating this Hover Widget can bring up a virtual scroll ring. With this tool, users can make a circling gesture clock-wise to scroll down, and counter-clockwise to scroll up, for example.

The Right Click Hover Widget 1108 activates a right click tool. Once activated, the cursor is drawn as a right button icon. Subsequent pen down events simulate the functionality generally associated with clicking the right mouse button. For example, clicking on a pen stroke brings up a marking menu, providing options specific to that stroke, such as cut, copy, and/or properties.

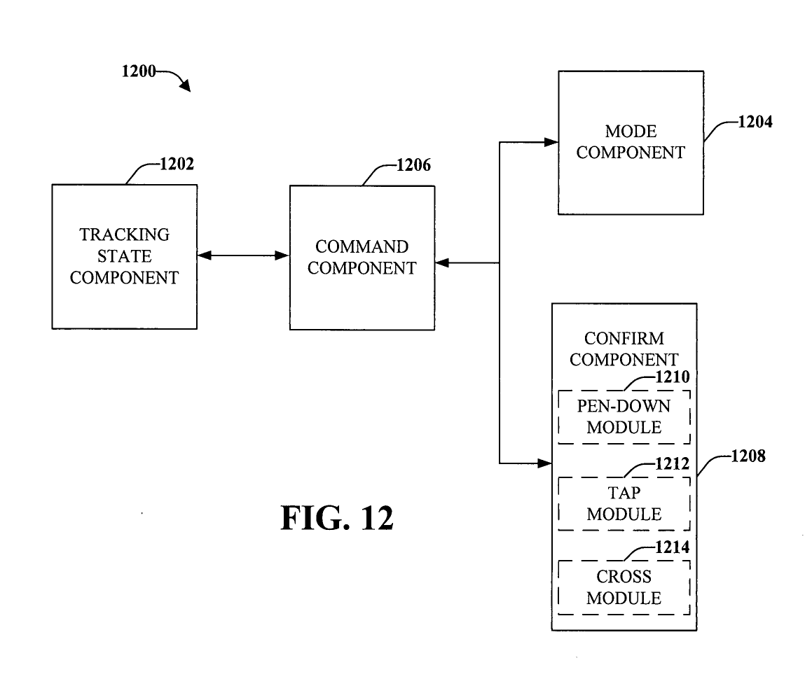

FIG. 12 illustrates a system 1200 for allowing a confirmation or activation of a command invoked in a tracking state. An object movement in a tracking state is detected by a tracking state component 1202 that interfaces with a mode component 1204 through a command component 1206 and/or a confirm component 1208. The command component 1206 can facilitate user visualization of a widget to invoke a command. The mode component 1204 is configured to determine which command is being invoked. The mode component 1204 can interface with a confirm component 1208 that is configured to receive a confirmation and/or activation of the command.

The confirm component 1208 can include a pen-down module 1210, a tap module 1212, and a cross module 1214. It is to be understood that the modules 1210, 1212, and 1214 can be separate components and there may be more or less components than those illustrated. All such modifications and/or alterations are intended to fall within the scope of the subject disclosure and appended claims.

The pen-down module 1210 is configured to detect a pen down activation. In a pen down activation, the user simply brings the object in contact with the activation zone after completing a gesture in the tracking state. If the embodiment employs a tunnel, the tunnel can be reset if the cursor leaves this activation zone before the pen or object contacts the display.

The tap module 1212 is configured to detect a tapping action by the user to activate a Hover Widget. Instead of just bringing the object in contact with the display, the user quickly taps the display (e.g., a pen down event followed by a pen up event). This technique can mitigate false activations.

The cross module 1214 is configured to detect a user crossing activation. For this activation the Hover Widget is activated as soon as the pen crosses the end of a tunnel, while still in the tracking state. It should be understood that the confirm component 1208 and associated modules 1210, 1212, and 1214 are optional and are intended to mitigate false activations.

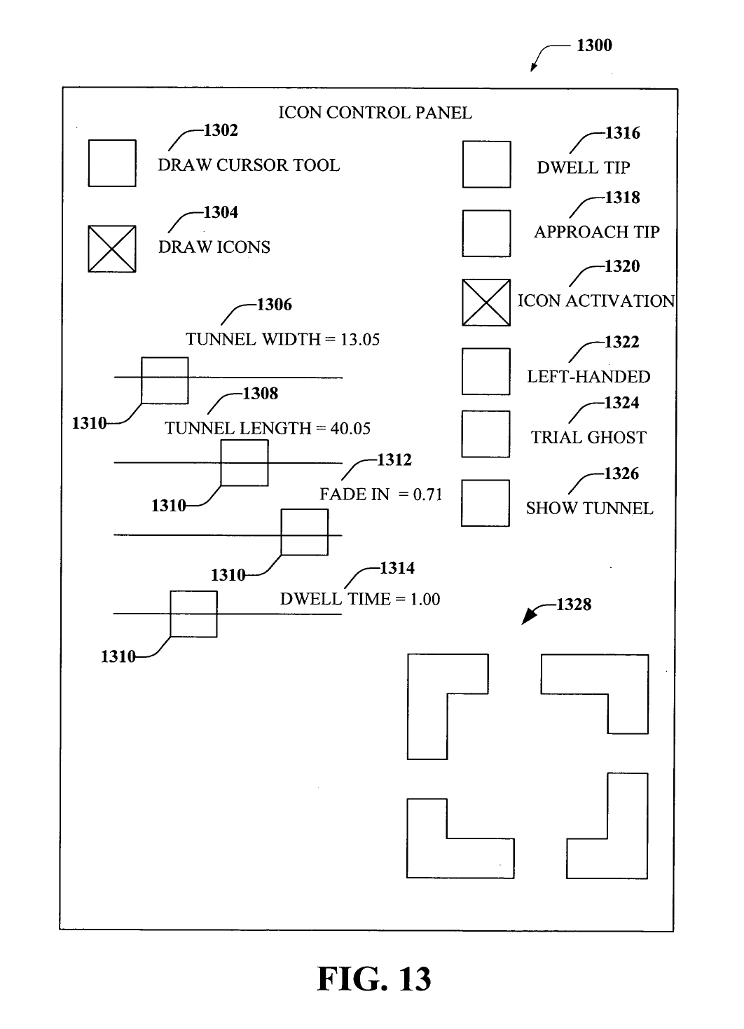

With reference now to FIG. 13, illustrated is an exemplary user interface control panel 1300 that can be utilized with the disclosed embodiments. The control panel 1300 can be opened, for example, by selecting a tab at the bottom right corner of the interface, although other means of opening can be utilized. The control panel 1300 allows users to explore the various hover widget settings and parameters.

The user can activate a draw cursor tool 1302 or a draw icons 1304 by selecting the box next to the indicated action. The draw cursor tool 1302, when activated, provides the user with a visualization of the cursor. The draw icon 1304, as shown, is currently active and provides the user with a visualization of the icons. The user can manipulate the tunnel width 1306 (currently set to 13.05), a tunnel length-1308 (currently set to 40.05). The user can manipulate the settings by moving the position of the respective selection boxes 1310. Similarly, the user can manipulate various parameters for visualization techniques, such as a fade in point 1312 (currently set at 0.71) and a dwelling fade-in time threshold 1314 (currently set at 1.00) by moving respective selection boxes 1310.

Users can also enable or disable various visualization techniques. Various examples include a swell tip 1316 and an approach tip 1318. Icon activation 1320 enables to user to crossing or tapping activation, for example. Other selectable parameters include left-handed activation 1322, trail ghost visualization 1324, and show or hide tunnel 1326. The user can also select an “L” shape configuration utilizing the tunnel selection tool 1328.

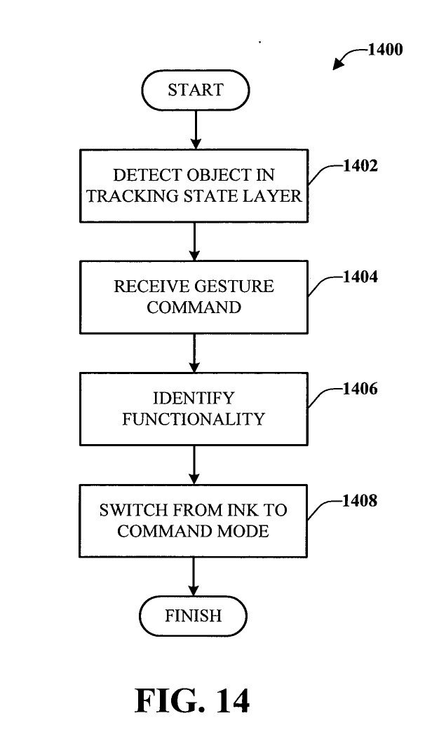

Referring to FIGS. 14-16, methodologies relating to using the tracking state to extend the capabilities of pen-operated devices are illustrated. While, for purposes of simplicity of explanation, the methodologies are shown and described as a series of acts, it is to be understood and appreciated that the methodologies are not limited by the order of acts, as some acts may, in accordance with these methodologies, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement the following methodologies.

Referring now to FIG. 14 illustrated is a methodology 1400 for utilizing a tracking mode to switch from an ink mode to a command mode. The method begins, at 1402, when an object is detected in the tracking state layer. This is a layer or position above the display screen in which the user is moving an object and is basically, hovering over or in front of the display screen or working area. The object can be anything that can point or that can be detected. Examples of objects include a pen, a finger, a marker, a pointing device, a ruler, etc.

At a substantially similar time as the object is detected as being in the tracking state, a gesture command can be received, at 1404. The gesture command is intended to include gestures that have a low likelihood of occurring by accident. The purpose of utilizing the tracking state is to prevent a gesture that is not recognized by the system to result in ink or a marking on the display surface (and underlying document) that the user would have to remove manually, slowing the user down. With the gesture performed in the tracking state, if the system does not recognize the gesture, the user simply redraws the gesture and there is no ink on the display surface (or underlying document).

The functionality associated with the gesture is identified, at 1406. The functionality can include a plurality of functions including a selection tool, right click, scrolling, etc. The functionality identified can be user-defined, such that a user selects a gesture and its functionality. The method continues, at 1408, where a switch from an ink mode to a command mode is made. The command mode relates to the functionality that was identified based on the gesture command.

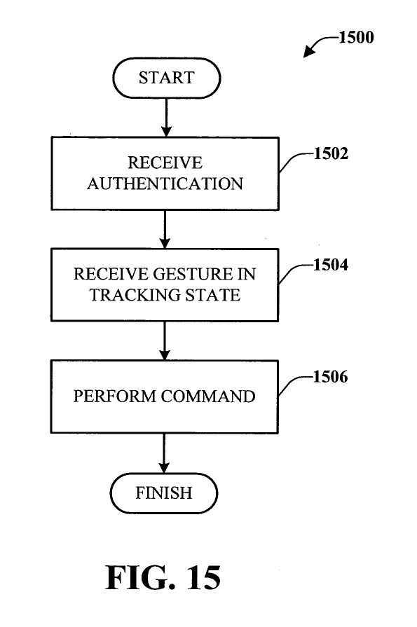

FIG. 15 illustrates a methodology 1500 for an initiation of a command after a user authentication and gesture. The method beings, at 1502, where an authentication is received from a user. This authentication can authorize a switch from an ink mode to a gesture mode. Once the authentication is verified, a gesture can be received in the tracking state, at 1504. The method now knows the user is in command mode and can support that mode by showing the user options, menus to select from, or it can perform other commands, at 1506, the relate to the authenticated gesture.

It should be understood that in another embodiment, the gesture can be received in the tracking state first, and then the user authenticates the gesture. This situation can invoke a user producing a detailed command sequence, defining the parameters and then authenticating by a notification that it is a command. Although this is an alternate embodiment and can work well in many situations, it may be undesirable because if a mistake occurs at the end of the gesture, before authentication, it will not be recognized.

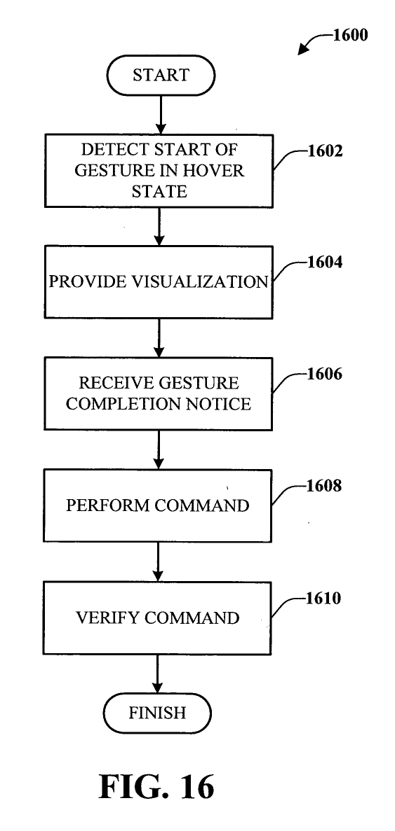

With reference now to FIG. 16, illustrated is a methodology 1600 for providing assistance to a user for completion of a gesture. The method begins, at 1602, when the start of a gesture in a hover state is detected. The hover state or tracking state is the area above or next to the working area (display) of a pen-operated device. The method can provide a visualization technique, at 1604, to assist the user in completing the gesture. For example, the method can infer which gesture and/or command the user desires based on the detected gesture beginning. Examples of visualization techniques can include a tunnel that a user can follow with the object, an activation zone fade-in that is displayed after a predefined percentage of progress has been made. Another visualization example is a road map that displays a plurality of available commands. The road map can be displayed after a dwelling fade-in has occurred. The user can select the desired visualization technique though a user interface. An experienced user may turn off all visualization techniques through the user interface.

Visualization also provides the user a means to verify that the command is complete, at 1608. Such verification can include a cursor tail turning a different color when the cursor reaches an activation zone. Another verification is a square (or other shaped) icon that is displayed. Other verifications can be provided and all such modifications are intended to fall within the scope of the subject disclosure.

The command is performed at 1610, where such command is a result of the gesture made in the tracking mode. After the command is complete, the method continues at 1612 and switches from a gesture mode back to an ink mode. The user can then write, draw, or make other markings (e.g., ink) on the display screen (and underlying document).

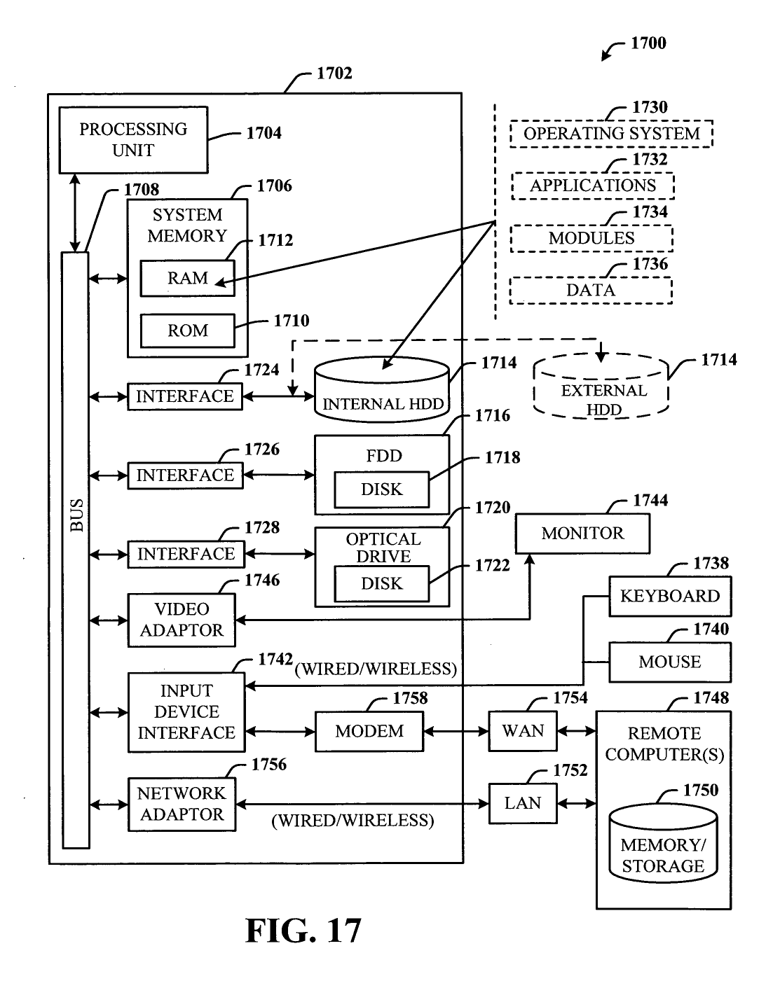

Referring now to FIG. 17, there is illustrated a block diagram of a computer operable to execute the disclosed architecture. In order to provide additional context for various aspects disclosed herein, FIG. 17 and the following discussion are intended to provide a brief, general description of a suitable computing environment 1700 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 17, the exemplary environment 1700 for implementing various aspects includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures may also be employed as the processing unit 1704.

The system bus 1708 can be any of several types of bus structure that may further interconnect to a memory bus (with or without a memory controller), a peripheral bus, and a local bus using any of a variety of commercially available bus architectures. The system memory 1706 includes read-only memory (ROM) 1710 and random access memory (RAM) 1712. A basic input/output system (BIOS) is stored in a non-volatile memory 1710 such as ROM, EPROM, EEPROM, which BIOS contains the basic routines that help to transfer information between elements within the computer 1702, such as during start-up. The RAM 1712 can also include a high-speed RAM such as static RAM for caching data.

The computer 1702 further includes an internal hard disk drive (HDD) 1714 (e.g., EIDE, SATA), which internal hard disk drive 1714 may also be configured for external use in a suitable chassis (not shown), a magnetic floppy disk drive (FDD) 1716, (e.g., to read from or write to a removable diskette 1718) and an optical disk drive 1720, (e.g., reading a CD-ROM disk 1722 or, to read from or write to other high capacity optical media such as the DVD). The hard disk drive 1714, magnetic disk drive 1716 and optical disk drive 1720 can be connected to the system bus 1708 by a hard disk drive interface 1724, a magnetic disk drive interface 1726 and an optical drive interface 1728, respectively. The interface 1724 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 1702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. It is appreciated that the various embodiments can be implemented with various commercially available operating systems or combinations of operating systems.

A user can enter commands and information into the computer 1702 through one or more wired/wireless input devices, e.g., a keyboard 938 and a pointing device, such as a mouse 1740. Other input devices (not shown) may include a microphone, an IR remote control, a joystick, a game pad, a stylus pen, touch screen, or the like. These and other input devices are often connected to the processing unit 1704 through an input device interface 1742 that is coupled to the system bus 1708, but can be connected by other interfaces, such as a parallel port, an IEEE 1394 serial port, a game port, a USB port, an IR interface, etc.

A monitor 1744 or other type of display device is also connected to the system bus 1708 via an interface, such as a video adapter 1746. In addition to the monitor 1744, a computer typically includes other peripheral output devices (not shown), such as speakers, printers, etc.

The computer 1702 may operate in a networked environment using logical connections via wired and/or wireless communications to one or more remote computers, such as a remote computer(s) 1748. The remote computer(s) 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wired/wireless connectivity to a local area network (LAN) 1752 and/or larger networks, e.g., a wide area network (WAN) 1754. Such LAN and WAN networking environments are commonplace in offices and companies, and facilitate enterprise-wide computer networks, such as intranets, all of which may connect to a global communications network, e.g., the Internet.

When used in a LAN networking environment, the computer 1702 is connected to the local network 1752 through a wired and/or wireless communication network interface or adapter 1756. The adaptor 1756 may facilitate wired or wireless communication to the LAN 1752, which may also include a wireless access point disposed thereon for communicating with the wireless adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wired or wireless device, is connected to the system bus 1708 via the serial port interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

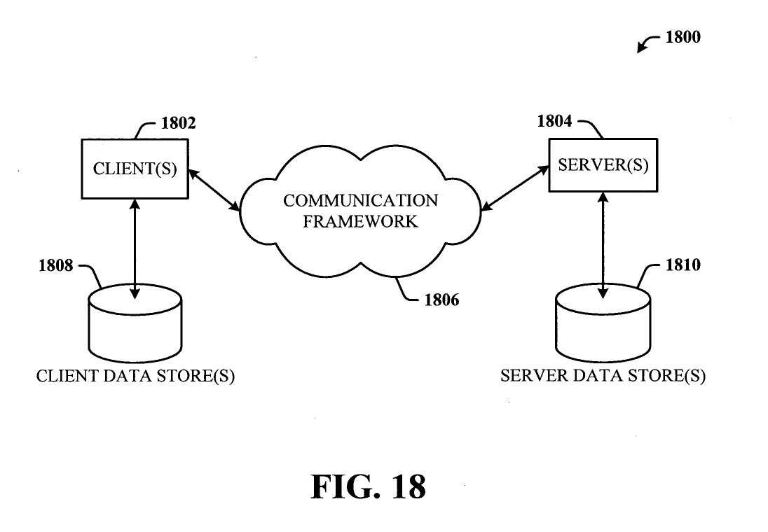

Referring now to FIG. 18, there is illustrated a schematic block diagram of an exemplary computing environment 1800 in accordance with the various embodiments. The system 1800 includes one or more client(s) 1802. The client(s) 1802 can be hardware and/or software (e.g., threads, processes, computing devices). The client(s) 1802 can house cookie(s) and/or associated contextual information by employing the various embodiments, for example.

The system 1800 also includes one or more server(s) 1804. The server(s) 1804 can also be hardware and/or software (e.g., threads, processes, computing devices). The servers 1804 can house threads to perform transformations by employing the various embodiments, for example. One possible communication between a client 1802 and a server 1804 can be in the form of a data packet adapted to be transmitted between two or more computer processes. The data packet may include a cookie and/or associated contextual information, for example. The system 1800 includes a communication framework 1806 (e.g., a global communication network such as the Internet) that can be employed to facilitate communications between the client(s) 1802 and the server(s) 1804.

Communications can be facilitated via a wired (including optical fiber) and/or wireless technology. The client(s) 1802 are operatively connected to one or more client data store(s) 1808 that can be employed to store information local to the client(s) 1802 (e.g., cookie(s) and/or associated contextual information). Similarly, the server(s) 1804 are operatively connected to one or more server data store(s) 1810 that can be employed to store information local to the servers 1804.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer implemented system comprising the following computer executable components:
a component that determines if an object is in a tracking state; and
a component that interprets a movement of the object and provides functionality based at least in part on the interpreted object movement.

2. The system of claim 1, further comprising:
a component that confirms the movement prior to completion of the functionality.

3. The system of claim 1, further comprising:
a guidance component that recommends to a user at least one motion to invoke a functionality.

4. The system of claim 3, further comprising:
a visible tunnel that outlines an object movement, a first stoke movement is extended if the stroke goes beyond a predefined length.

5. The system of claim 1, further comprising:
a component that detects at least one of a vertical motion and a horizontal motion.

6. The system of claim 1, further comprising:
a second component that senses at least a second object in the tracking state; and
a second component that interprets the movement of the second object and provides functionality distinct from the functionality provided in response to the object.

7. The system of claim 1, further comprising:
a component that discriminates the movement based on whether an angle or a scale of the movement is within predefined boundaries.

8. The system of claim 1, the movement is user-defined and confirmed by the system as a valid user-defined movement.

9. The system of claim 1, the movement is one of a one-stroke gesture, two-stroke gesture, three-stroke gesture, and a spiral gesture.

10. A computer implemented method comprising the following computer executable acts:
detecting a movement in an overlay layer of a display;
identifying at least one axis of motion of the movement; and
responding to the movement to facilitate a user-desired action.

11. The method of claim 10, further comprising:
receiving an authentication prior to responding to the motion.

12. The method of claim 11, the authentication is one of a pen down, a tap, and a crossing motion.

13. The method of claim 10, further comprising:
switching from an ink mode to a gesture mode to facilitate responding to the movement.

14. The method of claim 13, further comprising:
transferring from the gesture mode to an ink mode after responding to the movement.

15. The method of claim 10, further comprising:
receiving a request to assign a user-defined gesture to a command; and
determining if the user-defined gesture meets gesture parameters; and
assigning the user-defined gesture to the command if it meets gesture parameters.

16. The method of claim 10, after detecting a movement in an overlay layer of a display, further comprising:
providing a guidance tool to assist the user in completing the movement.

17. The method of claim 10, further comprising:
canceling a command if the user does not complete the gesture.

18. A computer executable system, comprising:
computer implemented means for recognizing a gesture in a hover state;
computer implemented means for switching from an ink mode to a gesture mode; and
computer implemented means for performing a command associated with the recognized gesture.

19. The system of claim 18, further comprising:
computer implemented means for offering the user guidance to complete the gesture.

20. The system of claim 18, further comprising:
computer implemented means for receiving a gesture authentication prior to performing the command associated with the recognized gesture.
